(19) United States
(12) Patent Application Publication
(10) Pub. No.: US 2026/0147694 A1
(43) Pub. Date: May 28, 2026

(54) DOMAIN AGNOSTIC AUTOMATION FRAMEWORK FOR WEB USER INTERFACE TESTING

(71) Applicant: Epicor Software Corporation, Austin, TX (US)

(72) Inventor: Francisco Adrian Garza Robledo, Monterrey (MX)

(21) Appl. No.: 18/958,877

(22) Filed: Nov. 25, 2024

(51) Int. Cl. G06F 11/3668

(52) U.S. Cl. CPC G06F 11/3688

(57) ABSTRACT

Testing web-based user interfaces across different software application domains can comprise providing an automation framework comprising a plurality of layers. Each layer of the can define a different set of one or more user interface components and executable code for interacting with each of the user interface components. A test script and an application under test can be executed. The test script can test a user interface of the application under test utilizing a combination of executable code for interacting with user interface components of the application under test from each layer of the plurality of layers of the automation framework. The combination of executable code for interacting with user interface components of the test script utilized by the test script can be based at least in part on a software application domain of the application under test.

### FIELD OF THE DISCLOSURE

Embodiments of the present disclosure relate generally to methods and systems for testing of web-based user interfaces and more particularly to a framework for testing of web-based user interfaces across different verticals of an enterprise software environment.

### BACKGROUND

Enterprise software is a type of software that helps businesses manage their core functions and processes. Such software can consist of different individual products or “verticals” for managing different aspects of the business. For example, these products can include a product or product suite for performing Enterprise Resource Planning (ERP), managing manufacturing processes, planning and managing distribution and/or a supply chain, etc. Each of these products or product suites can provide a wide range of different web-based user interfaces, e.g., webpages. During development of the products, testing is often done through automated interaction with these user interfaces. However, if changes are made to one of the interfaces, the automated test may not function properly unless the test scripts for executing the tests are updated which can be time consuming and costly. Hence, there is a need for improved methods and systems for testing web-based user interfaces across different products within enterprise software.

### BRIEF SUMMARY

Embodiments of the disclosure provide systems and methods for a framework for testing of web-based user interfaces across different verticals or software application domains of an enterprise software environment. According to one embodiment, a method for testing web-based user interfaces across a plurality of different software application domains can comprise providing an automation framework comprising a plurality of layers. Each layer of the plurality of layers can define a different set of one or more user interface components and executable code for interacting with each of the one or more user interface components. A test script and an application under test can be executed. The test script can test a user interface of the application under test utilizing a combination of executable code for interacting with user interface components of the application under test from each layer of the plurality of layers of the automation framework. The combination of executable code for interacting with user interface components of the test script utilized by the test script can be based at least in part on a software application domain of the application under test.

More specifically, the plurality of layers can comprise a generic component layer. The set of user interface components defined in the generic component layer can comprise user interface components utilized by software applications regardless of software application domain. Executing the test script can further comprise executing executable code defined in the generic component layer for interacting with at least one user interface component of the user interface of the application under test and based on user interface component located in the user interface of the application under test.

The plurality of layers can further comprise a common component layer. The set of user interface components defined in the common component layer can comprise user interface components utilized by software applications across the plurality of software application domains. Executing the test script can further comprise executing executable code defined in the common component layer for interacting with at least one user interface component of the user interface of the application under test and based on user interface components located in the user interface of the application under test.

The plurality of layers can further comprise a domain specific component layer. The set of user interface components defined in the domain specific component layer can comprise user interface components specific to each software application domain of the plurality of software application domains. Executing the test script can further comprise executing executable code defined in the domain specific component layer for interacting with at least one user interface component of the user interface of the application under test and based on user interface components located in the user interface of the application under test.

According to another embodiment, a system can comprise a processor and a memory coupled with and readable by the processor. The memory can store therein a set of instructions which, when executed by the processor, causes the processor to test web-based user interfaces across a plurality of different software application domains by providing an automation framework comprising a plurality of layers. Each layer of the plurality of layers can define a different set of one or more user interface components and executable code for interacting with each of the one or more user interface components. The instructions can further cause the processor to execute a test script and an application under test. The test script can test a user interface of the application under test utilizing a combination of executable code for interacting with user interface components of the application under test from each layer of the plurality of layers of the automation framework. The combination of executable code for interacting with user interface components of the test script utilized by the test script can be based at least in part on a software application domain of the application under test.

More specifically, the plurality of layers can comprise a generic component layer. The set of user interface components defined in the generic component layer can comprise user interface components utilized by software applications regardless of software application domain. Executing the test script can further comprise executing executable code defined in the generic component layer for interacting with at least one user interface component of the user interface of the application under test and based on user interface component located in the user interface of the application under test.

The plurality of layers can further comprise a common component layer. The set of user interface components defined in the common component layer can comprise user interface components utilized by software applications across the plurality of software application domains. Executing the test script can further comprise executing executable code defined in the common component layer for interacting with at least one user interface component of the user interface of the application under test and based on user interface components located in the user interface of the application under test.

The plurality of layers can further comprise a domain specific component layer. The set of user interface components defined in the domain specific component layer can comprise user interface components specific to each software application domain of the plurality of software application domains. Executing the test script can further comprise executing executable code defined in the domain specific component layer for interacting with at least one user interface component of the user interface of the application under test and based on user interface components located in the user interface of the application under test.

According to another embodiment, a non-transitory, computer-readable medium can comprise a set of instructions stored therein which, when executed by a processor, causes the processor to test web-based user interfaces across a plurality of different software application domains by providing an automation framework comprising a plurality of layers. Each layer of the plurality of layers can define a different set of one or more user interface components and executable code for interacting with each of the one or more user interface components. The instructions can further cause the processor to execute a test script and an application under test. The test script can test a user interface of the application under test utilizing a combination of executable code for interacting with user interface components of the application under test from each layer of the plurality of layers of the automation framework. The combination of executable code for interacting with user interface components of the test script utilized by the test script can be based at least in part on a software application domain of the application under test.

More specifically, the plurality of layers can comprise a generic component layer. The set of user interface components defined in the generic component layer can comprise user interface components utilized by software applications regardless of software application domain. Executing the test script can further comprise executing executable code defined in the generic component layer for interacting with at least one user interface component of the user interface of the application under test and based on user interface component located in the user interface of the application under test.

The plurality of layers can further comprise a common component layer. The set of user interface components defined in the common component layer can comprise user interface components utilized by software applications across the plurality of software application domains. Executing the test script can further comprise executing executable code defined in the common component layer for interacting with at least one user interface component of the user interface of the application under test and based on user interface components located in the user interface of the application under test.

The plurality of layers can further comprise a domain specific component layer. The set of user interface components defined in the domain specific component layer can comprise user interface components specific to each software application domain of the plurality of software application domains. Executing the test script can further comprise executing executable code defined in the domain specific component layer for interacting with at least one user interface component of the user interface of the application under test and based on user interface components located in the user interface of the application under test.

### BRIEF DESCRIPTION OF THE DRAWINGS

FIG. 1 is a block diagram illustrating elements of an exemplary computing environment in which embodiments of the present disclosure may be implemented.

FIG. 2 is a block diagram illustrating elements of an exemplary computing device in which embodiments of the present disclosure may be implemented.

FIG. 3 is a block diagram illustrating a domain agnostic framework for testing web-based user interfaces across different verticals or software application domains of an enterprise software environment according to one embodiment of the present disclosure.

FIG. 4 is a flowchart illustrating an exemplary process for testing web-based user interfaces across different verticals or software application domains of an enterprise software environment according to one embodiment of the present disclosure.

FIG. 5 is a flowchart illustrating additional details of an exemplary process for testing web-based user interfaces across different verticals or software application domains of an enterprise software environment according to one embodiment of the present disclosure.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

In the following description, for the purposes of explanation, numerous specific details are set forth in order to provide a thorough understanding of various embodiments disclosed herein. It will be apparent, however, to one skilled in the art that various embodiments of the present disclosure may be practiced without some of these specific details. The ensuing description provides exemplary embodiments only and is not intended to limit the scope or applicability of the disclosure. Furthermore, to avoid unnecessarily obscuring the present disclosure, the preceding description omits a number of known structures and devices. This omission is not to be construed as a limitation of the scopes of the claims. Rather, the ensuing description of the exemplary embodiments will provide those skilled in the art with an enabling description for implementing an exemplary embodiment. It should however be appreciated that the present disclosure may be practiced in a variety of ways beyond the specific detail set forth herein.

While the exemplary aspects, embodiments, and/or configurations illustrated herein show the various components of the system collocated, certain components of the system can be located remotely, at distant portions of a distributed network, such as a Local-Area Network (LAN) and/or Wide-Area Network (WAN) such as the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the following description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, Non-Volatile Random-Access Memory (NVRAM), or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a Compact Disk Read-Only Memory (CD-ROM), any other optical medium, punch cards, paper tape, any other physical medium with patterns of holes, a Random-Access Memory (RAM), a Programmable Read-Only Memory (PROM), and Erasable Programable Read-Only Memory (EPROM), a Flash-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

A “computer readable signal” medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, Radio Frequency (RF), etc., or any suitable combination of the foregoing.

The terms “determine,” “calculate,” and “compute,” and variations thereof, as used herein, are used interchangeably and include any type of methodology, process, mathematical operation or technique.

It shall be understood that the term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the disclosure, brief description of the drawings, detailed description, abstract, and claims themselves.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as Programmable Logic Device (PLD), Programmable Logic Array (PLA), Field Programmable Gate Array (FPGA), Programmable Array Logic (PAL), special purpose computer, any comparable means, or the like. In general, any device(s) or means capable of implementing the methodology illustrated herein can be used to implement the various aspects of this disclosure. Exemplary hardware that can be used for the disclosed embodiments, configurations, and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or Very Large-Scale Integration (VLSI) design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or Common Gateway Interface (CGI) script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

Various additional details of embodiments of the present disclosure will be described below with reference to the figures. While the flowcharts will be discussed and illustrated in relation to a particular sequence of events, it should be appreciated that changes, additions, and omissions to this sequence can occur without materially affecting the operation of the disclosed embodiments, configuration, and aspects.

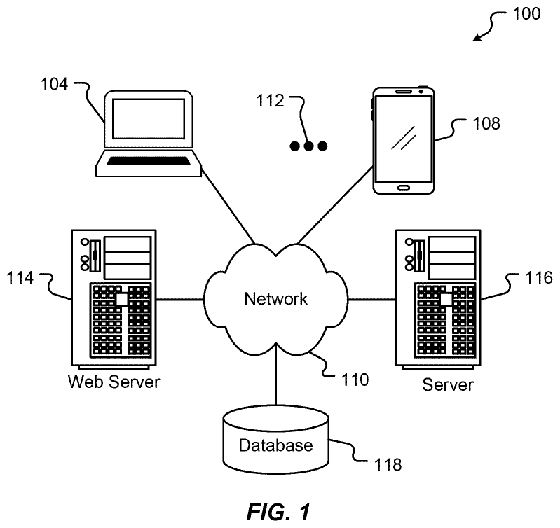

FIG. 1 is a block diagram illustrating elements of an exemplary computing environment in which embodiments of the present disclosure may be implemented. More specifically, this example illustrates a computing environment 100 that may function as the servers, user computers, or other systems provided and described herein. The environment 100 includes one or more user computers, or computing devices, such as a computing device 104, a communication device 108, and/or more 112. The computing devices 104, 108, 112 may include general purpose personal computers (including, merely by way of example, personal computers, and/or laptop computers running various versions of Microsoft Corp.'s Windows® and/or Apple Corp.'s Macintosh® operating systems) and/or workstation computers running any of a variety of commercially-available UNIX® or UNIX-like operating systems. These computing devices 104, 108, 112 may also have any of a variety of applications, including for example, database client and/or server applications, and web browser applications. Alternatively, the computing devices 104, 108, 112 may be any other electronic device, such as a thin-client computer, Internet-enabled mobile telephone, and/or personal digital assistant, capable of communicating via a network 110 and/or displaying and navigating web pages or other types of electronic documents. Although the exemplary computer environment 100 is shown with two computing devices, any number of user computers or computing devices may be supported.

Environment 100 further includes a network 110. The network 110 may can be any type of network familiar to those skilled in the art that can support data communications using any of a variety of commercially-available protocols, including without limitation Session Initiation Protocol (SIP), Transmission Control Protocol/Internet Protocol (TCP/IP), Systems Network Architecture (SNA), Internetwork Packet Exchange (IPX), AppleTalk, and the like. Merely by way of example, the network 110 maybe a Local Area Network (LAN), such as an Ethernet network, a Token-Ring network and/or the like; a wide-area network; a virtual network, including without limitation a Virtual Private Network (VPN); the Internet; an intranet; an extranet; a Public Switched Telephone Network (PSTN); an infra-red network; a wireless network (e.g., a network operating under any of the IEEE 802.9 suite of protocols, the Bluetooth® protocol known in the art, and/or any other wireless protocol); and/or any combination of these and/or other networks.

The system may also include one or more servers 114, 116. In this example, server 114 is shown as a web server and server 116 is shown as an application server. The web server 114, which may be used to process requests for web pages or other electronic documents from computing devices 104, 108, 112. The web server 114 can be running an operating system including any of those discussed above, as well as any commercially-available server operating systems. The web server 114 can also run a variety of server applications, including SIP servers, HyperText Transfer Protocol (secure) (HTTP(s)) servers, FTP servers, CGI servers, database servers, Java servers, and the like. In some instances, the web server 114 may publish operations available operations as one or more web services.

The environment 100 may also include one or more file and or/application servers 116, which can, in addition to an operating system, include one or more applications accessible by a client running on one or more of the computing devices 104, 108, 112. The server(s) 116 and/or 114 may be one or more general purpose computers capable of executing programs or scripts in response to the computing devices 104, 108, 112. As one example, the server 116, 114 may execute one or more web applications. The web application may be implemented as one or more scripts or programs written in any programming language, such as Java™, C, C#®, or C++, and/or any scripting language, such as Perl, Python, or Tool Command Language (TCL), as well as combinations of any programming/scripting languages. The application server(s) 116 may also include database servers, including without limitation those commercially available from Oracle®, Microsoft®, Sybase®, IBM® and the like, which can process requests from database clients running on a computing device 104, 108, 112.

The web pages created by the server 114 and/or 116 may be forwarded to a computing device 104, 108, 112 via a web (file) server 114, 116. Similarly, the web server 114 may be able to receive web page requests, web services invocations, and/or input data from a computing device 104, 108, 112 (e.g., a user computer, etc.) and can forward the web page requests and/or input data to the web (application) server 116. In further embodiments, the server 116 may function as a file server. Although for ease of description, FIG. 1 illustrates a separate web server 114 and file/application server 116, those skilled in the art will recognize that the functions described with respect to servers 114, 116 may be performed by a single server and/or a plurality of specialized servers, depending on implementation-specific needs and parameters. The computer systems 104, 108, 112, web (file) server 114 and/or web (application) server 116 may function as the system, devices, or components described herein.

The environment 100 may also include a database 118. The database 118 may reside in a variety of locations. By way of example, database 118 may reside on a storage medium local to (and/or resident in) one or more of the computers 104, 108, 112, 114, 116. Alternatively, it may be remote from any or all of the computers 104, 108, 112, 114, 116, and in communication (e.g., via the network 110) with one or more of these. The database 118 may reside in a Storage-Area Network (SAN) familiar to those skilled in the art. Similarly, any necessary files for performing the functions attributed to the computers 104, 108, 112, 114, 116 may be stored locally on the respective computer and/or remotely, as appropriate. The database 118 may be a relational database, such as Oracle 20i®, that is adapted to store, update, and retrieve data in response to Structured Query Language (SQL) formatted commands.

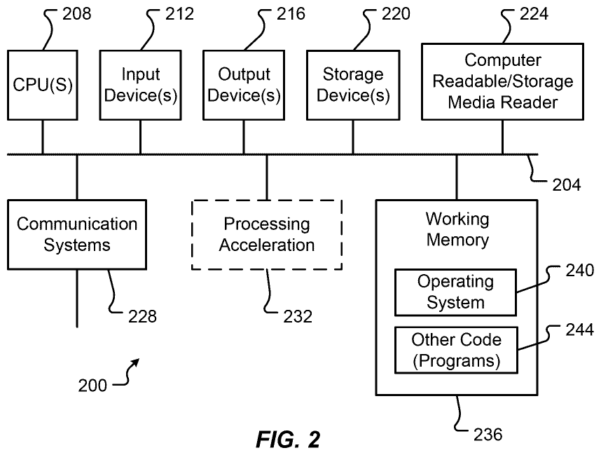

FIG. 2 is a block diagram illustrating elements of an exemplary computing device in which embodiments of the present disclosure may be implemented. More specifically, this example illustrates one embodiment of a computer system 200 upon which the servers, user computers, computing devices, or other systems or components described above may be deployed or executed. The computer system 200 is shown comprising hardware elements that may be electrically coupled via a bus 204. The hardware elements may include one or more Central Processing Units (CPUs) 208; one or more input devices 212 (e.g., a mouse, a keyboard, etc.); and one or more output devices 216 (e.g., a display device, a printer, etc.). The computer system 200 may also include one or more storage devices 220. By way of example, storage device(s) 220 may be disk drives, optical storage devices, solid-state storage devices such as a Random-Access Memory (RAM) and/or a Read-Only Memory (ROM), which can be programmable, flash-updateable and/or the like.

The computer system 200 may additionally include a computer-readable storage media reader 224; a communications system 228 (e.g., a modem, a network card (wireless or wired), an infra-red communication device, etc.); and working memory 236, which may include RAM and ROM devices as described above. The computer system 200 may also include a processing acceleration unit 232, which can include a Digital Signal Processor (DSP), a special-purpose processor, and/or the like.

The computer-readable storage media reader 224 can further be connected to a computer-readable storage medium, together (and, optionally, in combination with storage device(s) 220) comprehensively representing remote, local, fixed, and/or removable storage devices plus storage media for temporarily and/or more permanently containing computer-readable information. The communications system 228 may permit data to be exchanged with a network and/or any other computer described above with respect to the computer environments described herein. Moreover, as disclosed herein, the term “storage medium” may represent one or more devices for storing data, including ROM, RAM, magnetic RAM, core memory, magnetic disk storage mediums, optical storage mediums, flash memory devices and/or other machine-readable mediums for storing information.

The computer system 200 may also comprise software elements, shown as being currently located within a working memory 236, including an operating system 240 and/or other code 244. It should be appreciated that alternate embodiments of a computer system 200 may have numerous variations from that described above. For example, customized hardware might also be used and/or particular elements might be implemented in hardware, software (including portable software, such as applets), or both. Further, connection to other computing devices such as network input/output devices may be employed.

Examples of the processors 208 as described herein may include, but are not limited to, at least one of Qualcomm® Snapdragon® 800 and 801, Qualcomm® Snapdragon® 620 and 615 with 4G LTE Integration and 64-bit computing, Apple® A 7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i 5-4670K and i7-4770K 22 nm Haswell, Intel® Core® i 5-3570K 22 nm Ivy Bridge, the AMD® FX™ family of processors, AMD® FX- 4300, FX- 6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

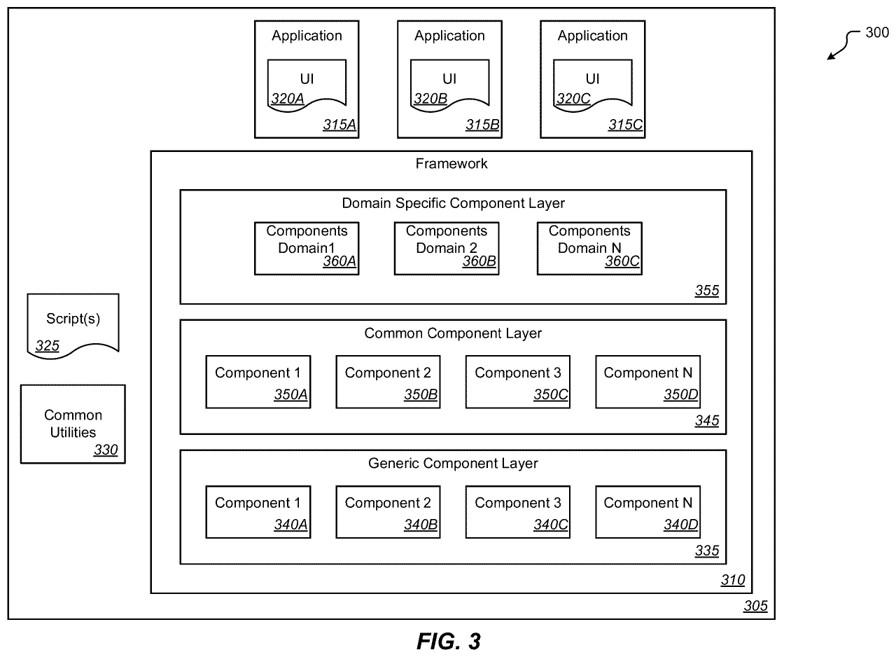

FIG. 3 is a block diagram illustrating a domain agnostic framework for testing web-based user interfaces across different verticals or software application domains of an enterprise software environment according to one embodiment of the present disclosure. As illustrated in this example, the environment 300 can comprise a test system 305. The test system can comprise any one or more servers and/or other computing devices as described above. The test system 305 can provide a multi-layered automation framework 310. Generally speaking, and as will be described in greater detail below, the testing system 305 can utilize a set of common utilities, e.g. a Representational State Transfer (RET) interface utility, a Structured Query Language (SQL) interface utility, a JavaScript Object Notation (JSON) utility, a file system interface utility, etc., and the framework 310 to test any number of applications 315A-315C by executing one or more test scripts 325 which interact with user interfaces 320A-320C, e.g., one or more web pages, of the applications 315A-315C to verify various functions of the applications 315A-315C.

According to embodiments of the present disclosure, the framework 310 can provide for domain agnostic testing of the user interfaces 320A-320C of the applications 315A-315C. For example, the applications 315A-315C can comprise various different verticals or products within an enterprise application suite. While such applications can share some common elements and functions, various other elements and functions are specific to the domain of that software application. The framework 310 provides a scalable, flexible, and robust solution for automating tests across different software products and UX platform layers. Embodiments described herein centralize necessary adjustments for user interface component updates, include built-in methods for common user interface interactions, and support code reuse through common component layers. Additionally, embodiments can employ a Page Object Model (POM) design pattern to automate Page Object creation, significantly reducing development time and enhancing test suite consistency.

More specifically, the framework 310 can comprise a generic component layer 335, a common component layer 345, and a domain specific component layer 355. The generic component layer 335 can comprise a base class which can define and extend various user interface components 340A-340D included in a layer. The generic component layer 335 can implement methods necessary for any user interface interaction, such as waiting for visibility or “enabling” of user interface elements. This abstraction allows script developers to avoid redundant coding, thereby streamlining the automation process. Examples of these methods can include, but are not limited to waitForVisibility and waitForEnabled.

The common component layer 345 can define base components 350A-350D that are common across different products and verticals, i.e., across software application domains. For example, different products within an enterprise application suite may share pre-defined user interface elements in order to provide consistency across applications of the suite. Such components can include, for example, comboboxes, dropdowns, and/generic components. The framework's implementation of these components 350A-350D allows any product to leverage the provided code, promoting reusability and consistency.

The domain specific component layer 355 can define components 350A-350C specific to individual software product domains, i.e., products or verticals within an enterprise application suite. The domain specific component layer 355 can employ a Page-Object Model (POM) design pattern, allowing automated tools to generate Page Objects (POs) for various screens. This significantly reduces the time required to develop POs, enhancing productivity and consistency across test suites.

Stated another way, the testing system 305 can perform testing on web-based user interfaces across a plurality of different software application domains by providing an automation framework 310 comprising a plurality of layers 335, 345, and 355. Each layer of the plurality of layers 335, 345, and 355 can define a different set of one or more user interface components and executable code for interacting with each of the one or more user interface components. A test script 325 and an application under test 315A can be executed. The test script 325 can test a user interface 320A of the application under test 315A utilizing a combination of executable code for interacting with user interface components of the application under test from each layer of the plurality of layers 335, 345, and 355 of the automation framework 310. The combination of executable code for interacting with user interface components of the test script utilized by the test script can be based at least in part on a software application domain of the application under test 315A.

More specifically, the plurality of layers 335, 345, and 355 can comprise a generic component layer 335. The set of user interface components 340A-340D and associated executable code for each defined in the generic component layer 335 can comprise user interface components utilized by software applications regardless of software application domain. Executing the test script 325 can further comprise executing the executable code defined in the generic component layer 335 for interacting with at least one user interface component located in the user interface 320A of the application under test 315A.

The plurality of layers 335, 345, and 355 can further comprise a common component layer 345. The set of user interface components 350A-350D and associated executable code for each defined in the common component layer 345 can comprise user interface components utilized by software applications across the plurality of software application domains, i.e., that are common to different products or verticals. Executing the test script 325 can further comprise executing the executable code defined in the common component layer 345 for interacting with at least one user interface component located in the user interface 320A of the application under test 315A.

The plurality of layers 335, 345, and 355 can further comprise a domain specific component layer 355. The set of user interface components 360A-360C and associated executable code for each defined in the domain specific component layer 355 can comprise user interface components specific to each software application domain of the plurality of software application domains. Executing the test script 325 can further comprise executing the executable code defined in the domain specific component layer 355 for interacting with at least one user interface component located in the user interface 320A of the application under test 315A.

Traditionally, end-to-end user automation testing is highly fragile as tests often break when components or applications change. Embodiments of the present disclosure provide a stable interface for testing, even when significant changes are made to the underlying applications. This centralized abstraction point allows tests to remain stable and functional even if when replacing or modifying user interface controls extensively, such as changing a textbox input to a dropdown control, thereby significantly reducing the maintenance cost of test suites.

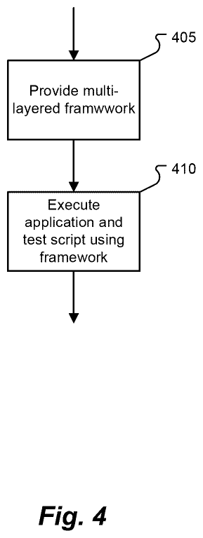

FIG. 4 is a flowchart illustrating an exemplary process for testing web-based user interfaces across different verticals or software application domains of an enterprise software environment according to one embodiment of the present disclosure. As illustrated in this example, testing web-based user interfaces across a plurality of different software application domains can comprise providing 405 an automation framework comprising a plurality of layers. Each layer of the plurality of layers can define a different set of one or more user interface components and executable code for interacting with each of the one or more user interface components. A test script and an application under test can be executed 410. The test script can test a user interface of the application under test utilizing a combination of executable code for interacting with user interface components of the application under test from each layer of the plurality of layers of the automation framework. The combination of executable code for interacting with user interface components of the test script utilized by the test script can be based at least in part on a software application domain of the application under test.

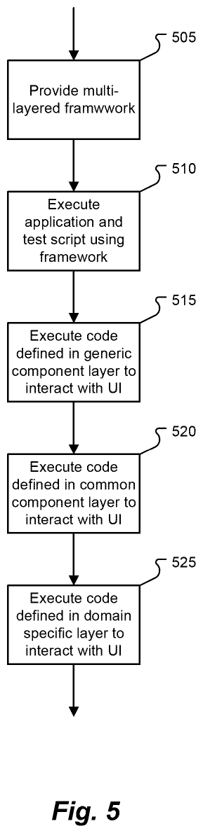

FIG. 5 is a flowchart illustrating additional details of an exemplary process for testing web-based user interfaces across different verticals or software application domains of an enterprise software environment according to one embodiment of the present disclosure. As illustrated in this example, testing web-based user interfaces across a plurality of different software application domains can comprise providing 505 an automation framework comprising a plurality of layers. Each layer of the plurality of layers can define a different set of one or more user interface components and executable code for interacting with each of the one or more user interface components. A test script and an application under test can be executed 410. The test script can test a user interface of the application under test utilizing a combination of executable code for interacting with user interface components of the application under test from each layer of the plurality of layers of the automation framework. The combination of executable code for interacting with user interface components of the test script utilized by the test script can be based at least in part on a software application domain of the application under test.

More specifically, the plurality of layers can comprise a generic component layer. The set of user interface components defined in the generic component layer can comprise user interface components utilized by software applications regardless of software application domain. Executing the test script can further comprise executing 515 executable code defined in the generic component layer for interacting with at least one user interface component of the user interface of the application under test and based on user interface component located in the user interface of the application under test.

The plurality of layers can further comprise a common component layer. The set of user interface components defined in the common component layer can comprise user interface components utilized by software applications across the plurality of software application domains. Executing the test script can further comprise executing 520 executable code defined in the common component layer for interacting with at least one user interface component of the user interface of the application under test and based on user interface components located in the user interface of the application under test.

The plurality of layers can further comprise a domain specific component layer. The set of user interface components defined in the domain specific component layer can comprise user interface components specific to each software application domain of the plurality of software application domains. Executing the test script can further comprise executing 525 executable code defined in the domain specific component layer for interacting with at least one user interface component of the user interface of the application under test and based on user interface components located in the user interface of the application under test.

The present disclosure, in various aspects, embodiments, and/or configurations, includes components, methods, processes, systems, and/or apparatus substantially as depicted and described herein, including various aspects, embodiments, configurations embodiments, sub-combinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method for testing web-based user interfaces across a plurality of different software application domains, the method comprising:
providing, by a processor of a test system, an automation framework comprising a plurality of layers, each layer of the plurality of layers defining a different set of one or more user interface components and executable code for interacting with each of the one or more user interface components; and
executing, by the processor of the test system, a test script and an application under test, wherein the test script tests a user interface of the application under test utilizing a combination of executable code for interacting with user interface components of the application under test from each layer of the plurality of layers of the automation framework, and wherein the combination of executable code for interacting with user interface components of the test script utilized by the test script is based at least in part on a software application domain of the application under test.

2. The method of claim 1, wherein the plurality of layers comprises a generic component layer and wherein the set of user interface components defined in the generic component layer comprises user interface components utilized by software applications regardless of software application domain.

3. The method of claim 2, wherein executing the test script further comprises executing executable code defined in the generic component layer for interacting with at least one user interface component of the user interface of the application under test and based on user interface component located in the user interface of the application under test.

4. The method of claim 3, wherein the plurality of layers comprises a common component layer and wherein the set of user interface components defined in the common component layer comprises user interface components utilized by software applications across the plurality of software application domains.

5. The method of claim 4, wherein executing the test script further comprises executing executable code defined in the common component layer for interacting with at least one user interface component of the user interface of the application under test and based on user interface components located in the user interface of the application under test.

6. The method of claim 5, wherein the plurality of layers comprises a domain specific component layer and wherein the set of user interface components defined in the domain specific component layer comprises user interface components specific to each software application domain of the plurality of software application domains.

7. The method of claim 6, wherein executing the test script further comprises executing executable code defined in the domain specific component layer for interacting with at least one user interface component of the user interface of the application under test and based on user interface components located in the user interface of the application under test.

8. A system comprising:
a processor; and
a memory coupled with and readable by the processor and storing therein a set of instructions which, when executed by the processor, causes the processor to test web-based user interfaces across a plurality of different software application domains by:
providing an automation framework comprising a plurality of layers, each layer of the plurality of layers defining a different set of one or more user interface components and executable code for interacting with each of the one or more user interface components; and
executing a test script and an application under test, wherein the test script tests a user interface of the application under test utilizing a combination of executable code for interacting with user interface components of the application under test from each layer of the plurality of layers of the automation framework, and wherein the combination of executable code for interacting with user interface components of the test script utilized by the test script is based at least in part on a software application domain of the application under test.

9. The system of claim 8, wherein the plurality of layers comprises a generic component layer and wherein the set of user interface components defined in the generic component layer comprises user interface components utilized by software applications regardless of software application domain.

10. The system of claim 9, wherein executing the test script further comprises executing executable code defined in the generic component layer for interacting with at least one user interface component of the user interface of the application under test and based on user interface component located in the user interface of the application under test.

11. The system of claim 10, wherein the plurality of layers comprises a common component layer and wherein the set of user interface components defined in the common component layer comprises user interface components utilized by software applications across the plurality of software application domains.

12. The system of claim 11, wherein executing the test script further comprises executing executable code defined in the common component layer for interacting with at least one user interface component of the user interface of the application under test and based on user interface components located in the user interface of the application under test.

13. The system of claim 12, wherein the plurality of layers comprises a domain specific component layer and wherein the set of user interface components defined in the domain specific component layer comprises user interface components specific to each software application domain of the plurality of software application domains.

14. The system of claim 13, wherein executing the test script further comprises executing executable code defined in the domain specific component layer for interacting with at least one user interface component of the user interface of the application under test and based on user interface components located in the user interface of the application under test.

15. A non-transitory, computer-readable medium comprising a set of instructions stored therein which, when executed by a processor, causes the processor to test web-based user interfaces across a plurality of different software application domains by:
providing an automation framework comprising a plurality of layers, each layer of the plurality of layers defining a different set of one or more user interface components and executable code for interacting with each of the one or more user interface components; and
executing a test script and an application under test, wherein the test script tests a user interface of the application under test utilizing a combination of executable code for interacting with user interface components of the application under test from each layer of the plurality of layers of the automation framework, and wherein the combination of executable code for interacting with user interface components of the test script utilized by the test script is based at least in part on a software application domain of the application under test.

16. The non-transitory, computer-readable medium of claim 15, wherein the plurality of layers comprises a generic component layer and wherein the set of user interface components defined in the generic component layer comprises user interface components utilized by software applications regardless of software application domain.

17. The non-transitory, computer-readable medium of claim 16, wherein executing the test script further comprises executing executable code defined in the generic component layer for interacting with at least one user interface component of the user interface of the application under test and based on user interface component located in the user interface of the application under test.

18. The non-transitory, computer-readable medium of claim 17, wherein the plurality of layers comprises a common component layer and wherein the set of user interface components defined in the common component layer comprises user interface components utilized by software applications across the plurality of software application domains.

19. The non-transitory, computer-readable medium of claim 18, wherein executing the test script further comprises executing executable code defined in the common component layer for interacting with at least one user interface component of the user interface of the application under test and based on user interface components located in the user interface of the application under test.

20. The non-transitory, computer-readable medium of claim 19, wherein the plurality of layers comprises a domain specific component layer, wherein the set of user interface components defined in the domain specific component layer comprises user interface components specific to each software application domain of the plurality of software application domains, and wherein executing the test script further comprises executing executable code defined in the domain specific component layer for interacting with at least one user interface component of the user interface of the application under test and based on user interface components located in the user interface of the application under test.
